(19) United States
(12) Patent Application Publication
(10) Pub. No.: US 2026/0195740 A1
(43) Pub. Date: Jul. 9, 2026

(54) Decentralized Cellular Economic Ecosystem Model for Web3

(71) Applicant: FURONG BEI, SAN GABRIEL, CA (US)

(72) Inventor: FURONG BEI, SAN GABRIEL, CA (US)

(21) Appl. No.: 19/080,825

(22) Filed: Mar. 15, 2025

Related U.S. Application Data
(63) Continuation-in-part of application No. 19/072,412, filed on Mar. 6, 2025.
(63) Continuation-in-part of application No. 19/053,406, filed on Feb. 13, 2025, now abandoned.
(63) Continuation-in-part of application No. 19/059,324, filed on Feb. 21, 2025, now abandoned.
(63) Continuation-in-part of application No. 19/064,589, filed on Feb. 26, 2025, now abandoned.
(63) Continuation-in-part of application No. 19/070,545, filed on Mar. 5, 2025.
(63) Continuation-in-part of application No. 19/053,450, filed on Feb. 14, 2025, now abandoned.
(63) Continuation-in-part of application No. 19/069,278, filed on Mar. 4, 2025.
(63) Continuation-in-part of application No. 19/074,355, filed on Mar. 8, 2025.
(63) Continuation-in-part of application No. 19/051,353, filed on Feb. 12, 2025, now abandoned.
(63) Continuation-in-part of application No. 19/056,745, filed on Feb. 19, 2025.
(63) Continuation-in-part of application No. 19/070,548, filed on Mar. 5, 2025.
(63) Continuation-in-part of application No. 19/066,022, filed on Feb. 27, 2025, now abandoned.
(63) Continuation-in-part of application No. 19/069,257, filed on Mar. 4, 2025.
(63) Continuation-in-part of application No. 19/078,271, filed on Mar. 12, 2025.
(63) Continuation-in-part of application No. 19/060,652, filed on Feb. 22, 2025, now abandoned.
(63) Continuation-in-part of application No. 19/078,276, filed on Mar. 13, 2025.
(63) Continuation-in-part of application No. 19/051,584, filed on Feb. 12, 2025, now abandoned.
(63) Continuation-in-part of application No. 19/067,936, filed on Mar. 2, 2025.
(63) Continuation-in-part of application No. 19/067,907, filed on Mar. 2, 2025.
(63) Continuation-in-part of application No. 19/066,179, filed on Feb. 28, 2025, now abandoned.
(63) Continuation-in-part of application No. 19/072,953, filed on Mar. 6, 2025.
(63) Continuation-in-part of application No. 19/057,972, filed on Feb. 19, 2025, now abandoned.
(63) Continuation-in-part of application No. 19/064,689, filed on Feb. 27, 2025.
(63) Continuation-in-part of application No. 19/069,205, filed on Mar. 3, 2025.
(63) Continuation-in-part of application No. 19/060,403, filed on Feb. 21, 2025, now abandoned.
(63) Continuation-in-part of application No. 19/060,663, filed on Feb. 22, 2025.
(63) Continuation-in-part of application No. 19/069,285, filed on Mar. 4, 2025.
(63) Continuation-in-part of application No. 19/074,352, filed on Mar. 8, 2025.
(63) Continuation-in-part of application No. 19/079,378, filed on Mar. 13, 2025.
(63) Continuation-in-part of application No. 19/069,268, filed on Mar. 4, 2025.
(63) Continuation-in-part of application No. 19/054,778, filed on Feb. 15, 2025, now abandoned.
(63) Continuation-in-part of application No. 19/058,739, filed on Feb. 20, 2025.
(63) Continuation-in-part of application No. 19/069,264, filed on Mar. 4, 2025.
(63) Continuation-in-part of application No. 19/057,393, filed on Feb. 19, 2025, now abandoned.
(63) Continuation-in-part of application No. 19/067,888, filed on Mar. 1, 2025, now abandoned.
(63) Continuation-in-part of application No. 19/067,732, filed on Feb. 28, 2025.
(63) Continuation-in-part of application No. 19/073,042, filed on Mar. 7, 2025.
(63) Continuation-in-part of application No. 19/073,040, filed on Mar. 7, 2025.
(63) Continuation-in-part of application No. 19/059,289, filed on Feb. 21, 2025, now abandoned.
(63) Continuation-in-part of application No. 19/072,075, filed on Mar. 6, 2025.
(63) Continuation-in-part of application No. 19/064,061, filed on Feb. 26, 2025, now abandoned.
(63) Continuation-in-part of application No. 19/072,905, filed on Mar. 6, 2025.
(63) Continuation-in-part of application No. 19/059,110, filed on Feb. 20, 2025, now abandoned.
(63) Continuation-in-part of application No. 19/073,058, filed on Mar. 7, 2025.
(63) Continuation-in-part of application No. 19/067,845, filed on Mar. 1, 2025.
(63) Continuation-in-part of application No. 19/076,910, filed on Mar. 11, 2025.
(60) Provisional application No. 63/759,784, filed on Feb. 18, 2025.

(51) Int. Cl. G06Q 20/38; G06Q 20/40; G06Q 40/03

(52) U.S. Cl. CPC G06Q 20/3821; G06Q 20/389; G06Q 20/4016; G06Q 20/405; G06Q 40/03

(57) ABSTRACT

A computer-implemented Web3 economic infrastructure forms interoperable autonomous economic nodes associated with respective participants, organizations, or jurisdictions. Each node is bound to a decentralized identity anchor and a namespace identifier and is governed by a signed policy bundle and one or more compliance rules. A routing engine selects execution paths across distributed ledgers, layered environments, liquidity pools, cross-ledger gateways, and institutional adapters. A settlement coordinator executes transfer, exchange, credit, or treasury operations and records decision and settlement receipts. An AI-assisted risk-control engine evaluates fraud, exposure, collateral, liquidity, and replay-prevention signals to authorize, limit, reroute, or deny operations. Optional embodiments support domain-based node activation, hybrid institutional-decentralized finance settlement, and multi-node governance for payments, lending, treasury, compliance, and cross-chain settlement.

### CROSS-REFERENCE TO RELATED APPLICATIONS

This application relates to U.S. application Ser. No. 19/078,276, Ser. No. 19/079,173, Ser. No. 19/079,295, Ser. No. 19/079,362, Ser. No. 19/079,378, Ser. No. 19/082,758, Ser. No. 19/082,791, Ser. No. 19/083,345, Ser. No. 19/083,357, Ser. No. 19/083,371, Ser. No. 19/083,396, and Ser. No. 19/083,430, and to related portfolio materials directed to decentralized identity, DAO governance, cross-chain financial infrastructure, decentralized credit, digital banking, and domain-addressable economic systems.

Any domestic-benefit, priority, continuation, divisional, or continuation-in-part relationship is claimed only to the extent properly set forth in an Application Data Sheet or other accepted filing record.

### INCORPORATION BY REFERENCE

The disclosures of the above-identified related applications and related materials are incorporated by reference to the extent permitted by law and to the extent not inconsistent with the present disclosure.

### TECHNICAL FIELD

The present disclosure relates to distributed computer systems, digital financial infrastructure, decentralized identity, cross-chain settlement, and automated risk control. More particularly, the disclosure relates to a Web3 economic architecture in which independently governed economic cells or nodes can be created for individuals, enterprises, communities, financial operators, or jurisdictions, while remaining interoperable through a shared routing, policy, settlement, and audit fabric.

The disclosure further relates to computer-implemented mechanisms for authenticating participants through decentralized identity anchors, evaluating policy and risk constraints, routing value transfers across heterogeneous blockchain or settlement networks, coordinating liquidity and lending functions, and producing auditable receipts for payment, exchange, credit, treasury, and governance actions.

### BACKGROUND

Existing Web3 systems often solve only isolated parts of a digital economy. Some systems emphasize identity but not settlement. Others provide settlement but not policy governance, liquidity coordination, or institution-facing integration. Many systems operate as single-chain silos and do not support coordinated operation among personal accounts, enterprise treasuries, communities, and cross-border financial operators.

Traditional financial infrastructure also remains fragmented. Cross-border payments are slow and expensive; different ledgers use incompatible state models; credit decisions frequently depend on static or centralized records; and user-controlled identity is often subordinated to intermediaries. These technical and operational constraints hinder rapid settlement, auditable automation, and flexible creation of localized economic units.

In addition, existing decentralized systems commonly lack a unified way to instantiate a participant-specific economic node that can maintain its own policy profile, assets, governance rights, and transaction history while still participating in broader multi-party liquidity, exchange, treasury, and compliance workflows. The absence of a multi-cellular architecture limits composability and prevents scalable deployment of a civilization-scale digital economy.

There is therefore a need for a technically integrated Web3 economic infrastructure that supports identity-anchored autonomous nodes, cross-chain and cross-rail settlement, AI-assisted fraud and exposure control, privacy-preserving compliance, modular DAO governance, and domain-addressable service discovery across a large family of interoperable economic platforms.

### SUMMARY OF THE INVENTION

In one aspect, the disclosure provides a computer-implemented system that forms and operates a plurality of interoperable economic cells. Each cell is associated with a participant or group, is bound to a decentralized identity anchor, and is configured to hold assets, apply policy constraints, execute governance actions, and participate in transfers or settlements with other cells.

In another aspect, the disclosure provides a transaction and settlement coordinator that receives a requested transfer, exchange, loan, or treasury action; verifies the requesting node and counterparty node; evaluates a signed policy bundle and one or more risk scores; selects a route across one or more blockchains, Layer-2 networks, liquidity pools, or institutional adapters; and causes an atomic or transactionally consistent state update while producing a decision receipt and a settlement receipt.

In a further aspect, the disclosure provides an AI-assisted risk-control engine that evaluates fraud indicators, duplicate or replay patterns, liquidity conditions, exposure limits, collateral sufficiency, concentration metrics, volatility metrics, or behavioral consistency signals, and can automatically enforce caps, reserve rules, collateral thresholds, throttles, review states, or bounded rollback rules.

In another aspect, the disclosure provides a domain-based routing and service-discovery fabric through which a domain name, subdomain, or other namespace identifier resolves to one or more authoritative endpoints for policy, audit, exchange, lending, settlement, treasury, or governance services. This permits an ecosystem of independently managed services to remain technically interoperable.

In another aspect, the disclosure provides a multi-tier governance model in which local, community, enterprise, and supra-node policies can coexist. Policy changes can be proposed, voted on, approved, versioned, and activated through cryptographically verifiable governance events, while node-level operations continue under the policy version applicable to a given transaction time and jurisdictional context.

### BRIEF DESCRIPTION OF THE DRAWINGS

FIG. 1 illustrates a representative overall architecture for the disclosed decentralized cellular economic ecosystem, including identity anchoring, node instantiation, policy evaluation, settlement coordination, liquidity routing, risk control, namespace routing, institutional adaptation, and receipt storage.

FIG. 2 illustrates a representative node-formation and identity-binding workflow.

FIG. 3 illustrates a representative domain-addressable service-discovery and governance-activation workflow.

FIG. 4 illustrates a representative transaction and settlement flow across decentralized and institutional rails.

FIG. 5 illustrates a representative credit, collateral, liquidity, treasury, and AI-assisted risk-control loop.

FIG. 6 illustrates a representative computing environment for implementing the disclosed modules and services.

### DEFINITIONS

Economic Cell or Node: a computer-implemented account environment associated with a participant, organization, treasury, jurisdiction, or service operator, and configured to maintain assets, rules, receipts, permissions, and interoperable transaction capability.

Identity Anchor: a decentralized identifier, credential-bound identifier, NFT-bound identifier, soulbound token, public-key credential, or equivalent cryptographic anchor used to authenticate or authorize a node or node operator.

Policy Bundle: a signed and versioned data structure that specifies one or more authorization rules, fee rules, routing rules, reserve rules, collateral rules, jurisdictional rules, privacy controls, audit permissions, or governance activation times.

Decision Receipt: a machine-readable receipt that records evaluation of a requested operation, including one or more of a rule identifier, policy version, reason code, risk score, timestamp, and review status.

Settlement Receipt: a machine-readable receipt that records execution or finality of a transfer, exchange, swap, loan, or clearing operation, including one or more route identifiers, ledger identifiers, pool identifiers, counterparty references, amount fields, and finality fields.

Institutional Adapter: a gateway or interface configured to connect a decentralized node or protocol flow to an external payment rail, bank, custodian, clearinghouse, regulated entity, or other non-native settlement system.

Liquidity Routing Engine: a software module configured to select among one or more liquidity sources or execution venues according to pricing, slippage, availability, policy, timing, reserve, or exposure criteria.

Bounded Rollback: a controlled reversal, unwind, or compensating transaction process triggered under predefined conditions and constrained by policy, permissions, time windows, and evidentiary requirements.

Namespace Record: a signed or authenticated mapping between a human-readable domain identifier and one or more technical endpoints, contracts, public keys, or service descriptors.

Pluggable Compliance Block: a signed or authenticated compliance module configured to load jurisdiction-specific, institution-specific, industry-specific, or route-specific rules, including one or more KYC, AML, sanctions-screening, tax-reporting, reserve, disclosure, or eligibility constraints.

Co-Ownership Token: a tokenized participation instrument associated with a node, node family, treasury partition, or service layer, and configured to represent one or more of governance rights, dividend rights, fee-sharing rights, usage-linked participation, or revenue-allocation rights, subject to the applicable policy bundle and legal deployment constraints.

### DETAILED DESCRIPTION

### 1. Overall Architecture

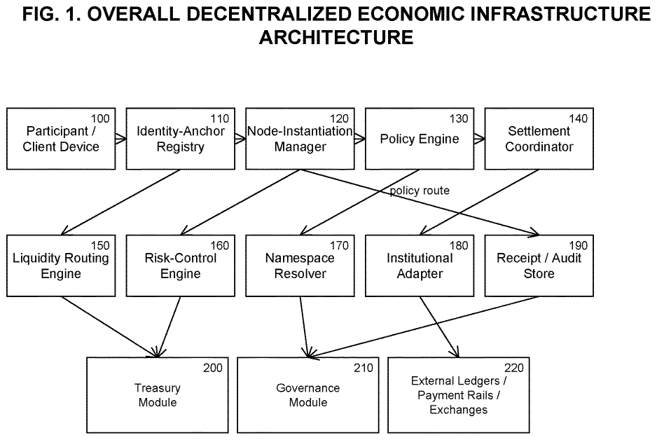

With reference to FIG. 1, a disclosed embodiment includes at least: (i) an identity-anchor registry; (ii) a node-instantiation manager; (iii) a policy engine; (iv) a transaction and settlement coordinator; (v) a liquidity routing engine; (vi) a risk-control engine; (vii) a namespace resolver; (viii) one or more institutional adapters; and (ix) a receipt and audit store.

Nodes may be personal nodes, merchant nodes, enterprise treasury nodes, DAO nodes, community nodes, public-infrastructure nodes, exchange nodes, insurance nodes, lending nodes, or jurisdiction-linked nodes. Each node can maintain its own balances, permissions, thresholds, asset registries, and governance state while also exposing interoperable interfaces for transactions with other nodes.

The architecture is ‘multi-cellular’ because economic activity is segmented into independently manageable cells that can operate autonomously without requiring a single centralized operator. The architecture is also ‘multi-system’ because different cells can be deployed on different ledgers, virtual machines, chains, Layer-2 systems, or institutional settlement environments.

### 2. Node Formation and Identity Binding

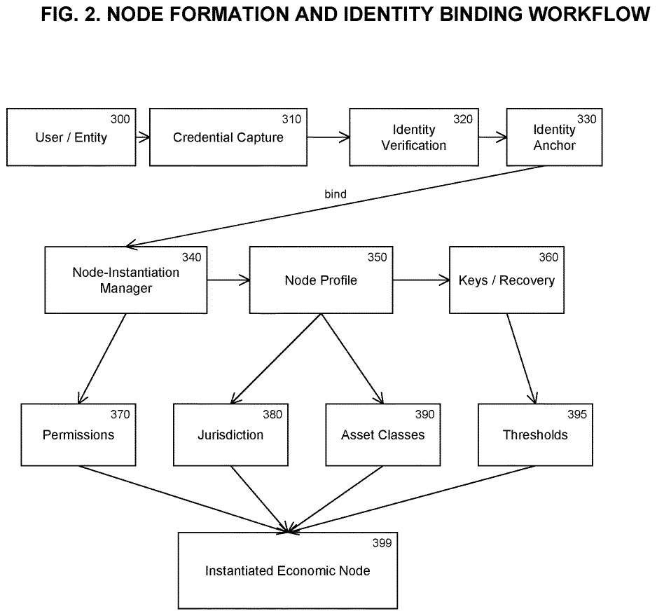

With reference to FIG. 2, when a new node is created, a node-instantiation manager associates the node with an identity anchor of a user, institution, or delegated operator. The identity anchor may include a decentralized identifier, a verifiable credential, a public-key credential, an NFT-bound identity reference, or another cryptographic credential set.

A node profile may further specify jurisdictional attributes, risk class, asset classes, spending or lending authorities, transaction windows, counterparty restrictions, and policy inheritance relationships. In some embodiments, subnodes can be created under a parent node for business units, projects, family structures, vaults, treasury partitions, or regional operations.

The identity binding may support user-controlled key rotation, recovery rules, threshold authorization, or delegated signatures. In some embodiments, a node can require multiple factors or multiple signers for selected classes of operations.

### 3. Domain-Addressable Service Discovery

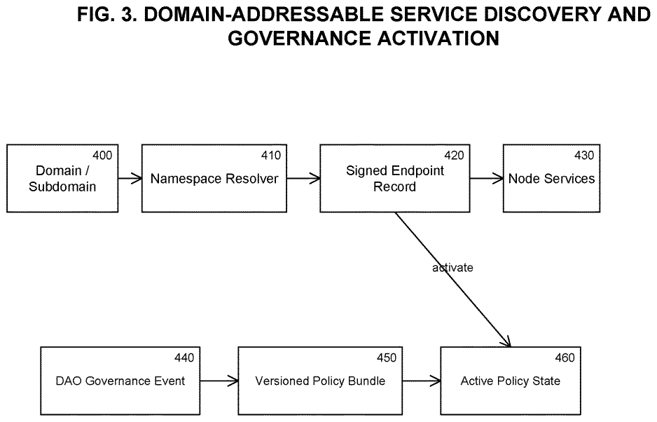

With reference to FIG. 3, a resolver may map a domain name, subdomain, path, or other namespace identifier to authoritative endpoint records for node services. In some embodiments the resolver also participates in domain-to-contract mapping, such that a namespace record resolves not only to a network endpoint, but also to one or more smart-contract addresses, policy references, audit endpoints, or treasury-control interfaces.

In illustrative embodiments, a domain such as ATMS.COM can expose banking or treasury interfaces, DAYS. US can expose payment interfaces, USDAO.COM can expose stable-value or reserve-management interfaces, and 24HWS.COM can expose commerce, membership, or governance services. A subdomain or delegated namespace may correspond to a merchant node, service node, or public-service node while preserving common verification and settlement semantics.

Namespace resolution can be implemented through signed DNS-compatible records, smart-contract registries, application-layer directories, or hybrid mappings. A node or client device can verify an endpoint record before initiating a financial operation.

### 4. Policy Engine and Governance Activation

Each requested operation is evaluated against a policy bundle that is applicable to the initiating node, the counterparty node, the asset type, the jurisdiction, the time of the request, and the route selected for execution. Policy bundles may be signed and versioned so that an auditor can later determine which rule set governed a given operation.

Policies can encode transaction caps, whitelists or blacklists, reserve ratios, slippage limits, collateralization thresholds, review triggers, jurisdiction-routing requirements, disclosure requirements, and rollback rules. In some embodiments, one or more pluggable compliance blocks are loaded into the policy engine to reflect jurisdiction-specific KYC, AML, sanctions, tax, reporting, or institutional-adapter conditions without requiring redesign of the node itself.

Governance events may be created through one or more DAO layers. A local node governance layer can control permissions and budgets internal to a node. A community or network layer can control shared parameters such as reserve rules, fee schedules, or eligible service providers. Approved governance actions can publish updated policy bundles with future effective times.

### 5. Transaction and Settlement Flow

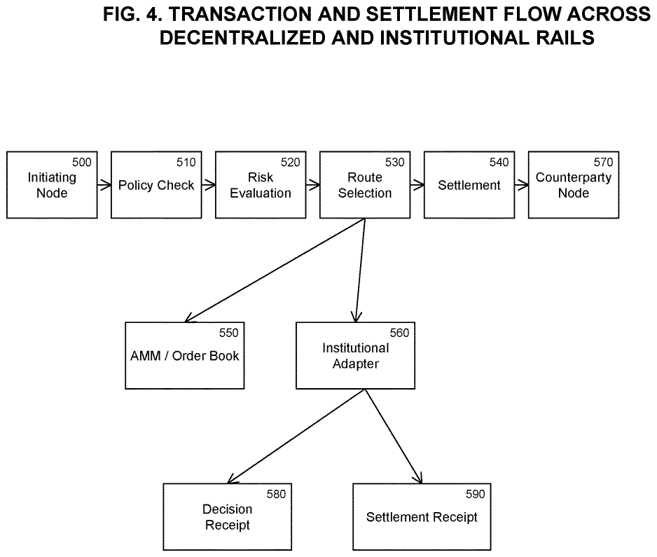

With reference to FIG. 4, for a transfer, swap, exchange, treasury movement, or payment instruction, the settlement coordinator receives a transaction request identifying an initiating node, a counterparty node or destination, an asset type, an amount, and one or more execution constraints.

The liquidity routing engine then selects one or more execution paths across available blockchains, Layer-2 channels, AMM pools, order-book venues, bilateral liquidity providers, or institutional adapters. Route selection can consider quoted price, slippage, network congestion, finality, reserve constraints, compliance constraints, or counterparty risk.

After route selection, the settlement coordinator causes a transactionally consistent update. In some embodiments, this is a single atomic state transition. In other embodiments, it is a coordinated multi-stage flow with compensating logic and receipt chaining. The coordinator writes a decision receipt and settlement receipt to a tamper-evident record store.

### 6. Hybrid DeFi and Institutional Finance Interface

In some embodiments, the architecture supports both decentralized and institutional settlement rails. A stable-value token, digital asset, governance token, receivable token, or other value unit may be exchanged through one or more decentralized pools and then settled or mirrored through one or more institutional adapters. In further embodiments, physical cards, stored-value credentials, or paper-instrument representations may be linked to on-ledger records and managed as optional hybrid payment instruments without changing the core settlement spine.

A multinational enterprise node, for example, can use the disclosed system to receive a cross-border payment into a decentralized settlement pool, net exposures across affiliates, convert a portion through an institutional adapter, and issue internal treasury receipts to subsidiary nodes. This can reduce settlement fragmentation while preserving auditability and route-level controls.

The institutional adapter may expose account-verification, payment-message formatting, custody confirmation, FX rate ingestion, reconciliation functions, or branch/merchant service hooks. In some embodiments, the adapter is policy-gated and can only be used for nodes meeting pluggable compliance requirements, reserve thresholds, or multi-signature approval conditions.

### 7. Lending and Credit Functions

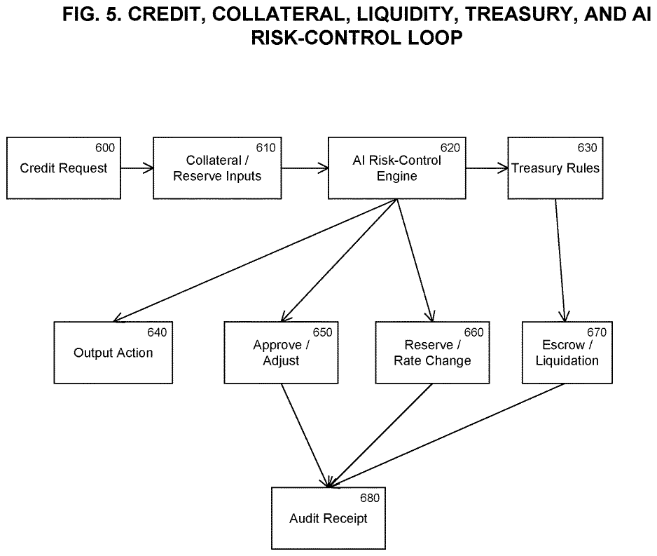

With reference to FIG. 5, the architecture may include lending services in which a node requests credit or liquidity against collateral, reserve backing, behavior-linked trust signals, transaction history, tokenized assets, tokenized receivables, or combinations thereof.

In some embodiments, the lending decision is not based solely on conventional overcollateralization. Instead, a disclosed risk-control engine can use a broader set of signals, such as transaction regularity, repayment history, verified business flows, treasury reserves, approved guarantees, identity maturity, sector category, or governance reputation. The resulting score may adjust interest, duration, borrowing capacity, review windows, or collateral thresholds.

Loans can be disbursed within a node family or across unrelated nodes. Loan receipts may record covenant rules, liquidation triggers, reserve requirements, and default-handling procedures.

### 8. Liquidity and Treasury Management

Node operators can maintain liquidity pools or treasury partitions associated with one or more node groups. The liquidity routing engine may allocate available liquidity among pools based on utilization, projected demand, yield, risk exposure, reserve requirements, or route efficiency. In some embodiments, a treasury partition is further associated with co-ownership, revenue-sharing, or participation tokens whose allocations are computed from usage, governance participation, contribution metrics, or predefined treasury rules.

A treasury manager can automatically rebalance between stable-value assets, governance assets, settlement buffers, or sector-specific assets. In some embodiments, a treasury node maintains isolated compartments for operations, reserves, guarantees, emergency stabilization, or project funding.

Dynamic treasury rules can update fees, interest margins, yield allocations, reserve targets, dividend calculations, or revenue-sharing percentages in response to market or network conditions, while keeping an auditable record of the rule set that caused the update.

### 9. AI-Assisted Risk Control

The risk-control engine can evaluate one or more of: transaction anomalies, repeated pattern deviations, address linkage risk, pool concentration, liquidity stress, route instability, market volatility, exposure limits, credit deterioration, or replay patterns. The term ‘AI-assisted’ includes machine-learning models, deterministic scoring models, hybrid heuristic models, or ensembles that generate a control output usable by the policy engine.

The control output may be a risk score, a categorical action, a route prohibition, a reserve requirement, a collateral adjustment, a review state, or a bounded rollback flag. The policy engine can use this output to approve, deny, throttle, escrow, defer, or partially route a transaction.

Importantly, the disclosed architecture does not rely on an abstract managerial rule alone. It ties risk evaluation to concrete routing, authorization, liquidity allocation, and settlement-control actions that change how the underlying distributed system executes an operation.

### 10. Privacy, Compliance, and Audit

Privacy-preserving verification can be used for compliance-sensitive operations. A node may prove possession of required attributes, reserve levels, authorization status, or jurisdictional eligibility without disclosing all underlying personal or institutional data. Selective disclosure, zero-knowledge proofs, signed attestations, or bounded evidence commitments may be used together with pluggable compliance blocks to preserve privacy while still satisfying route or adapter conditions.

Audit services may verify a decision receipt, settlement receipt, policy version, route identifier, proof reference, and any required exception records. Because receipts are linked to the actual execution path and policy version, the system supports post-event review without requiring a centralized operator to reconstruct the state from external notes.

Bounded rollback can be invoked when predefined evidentiary and policy conditions are met, for example in cases of fraud, technical inconsistency, duplicate execution, or counterparty failure. A rollback can be implemented as a compensating transaction, reserve release, escrow unwind, or other policy-authorized corrective action.

### 11. Sharding, Layering, and Scalability

The architecture supports sharded execution and layered settlement. Separate groups of nodes or asset classes can be assigned to different execution partitions while still sharing common policy and receipt semantics. The system can also separate fast path execution from later reconciliation, or can settle low-value flows differently from high-value or institution-facing flows.

Layer-2 systems may be used for rapid payments or internal node-family transfers, while base-chain settlement, checkpointing, or institutional reconciliation can be used for higher-value or lower-frequency operations. The disclosed multi-cellular design therefore supports both scale and traceability.

### 12. Asset Types and Sector Implementations

Assets handled by the disclosed architecture may include stable-value tokens, governance tokens, utility tokens, digital securities, receivables, tokenized domain-name rights, tokenized patent or intellectual-property interests, NFT-linked assets, co-ownership tokens, dividend or revenue-sharing tokens, and optional physical-payment representations linked to on-ledger records.

Sector implementations can include banking, payments, commerce, insurance, lending, healthcare, education, logistics, public-service delivery, or other categories. A sector node can inherit common infrastructure while maintaining customized policy bundles, compliance blocks, treasury logic, reporting endpoints, and asset-handling permissions.

Because nodes are domain-addressable and policy-governed, the same core architecture can serve as a technical operating layer for a broad economic ecosystem rather than a single-purpose application.

### 13. Representative Computing Environment

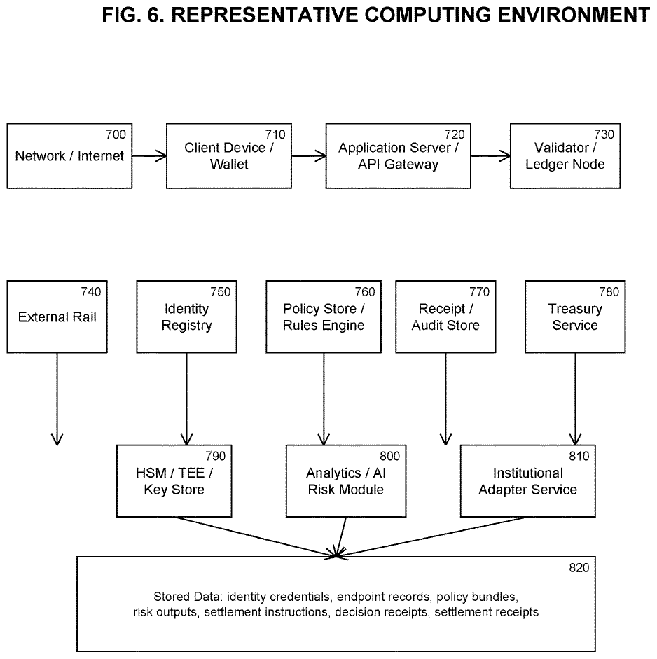

With reference to FIG. 6, a representative implementation environment can include one or more client devices, wallet applications, browser clients, validator nodes, application servers, API gateways, identity registries, policy stores, receipt stores, treasury-management services, institutional-adapter services, and external payment, custody, exchange, or clearing rails interconnected through one or more networks.

The disclosed modules may be implemented in software, firmware, hardware security modules, trusted execution environments, cloud services, edge devices, or combinations thereof. Data exchanged among modules may include signed endpoint records, identity credentials, policy bundles, risk scores, route identifiers, settlement instructions, compliance proofs, decision receipts, and settlement receipts.

### TECHNICAL ADVANTAGES

The disclosed system provides technical benefits including replacing hard-coded bilateral integrations with namespace-resolved endpoint records and signed policy bundles; improving distributed-network interoperability through route-aware multi-rail settlement; enabling node-specific authorization and treasury controls; and linking risk evaluation to concrete routing, authorization, liquidity-allocation, and settlement-control actions.

The architecture also supports modular deployment across payments, lending, treasury, compliance, and governance layers while maintaining common receipt semantics and policy-controlled interoperability.

These improvements are achieved through interoperable technical modules including identity anchors, namespace-resolved service endpoints, policy bundles, routing controls, receipt chaining, compliance gating, and settlement coordination.

### INDUSTRIAL APPLICABILITY

The invention is industrially applicable to digital identity, banking, payments, exchange and settlement, collateral management, treasury automation, digital-asset administration, domain and namespace infrastructure, hybrid institutional-decentralized finance interfaces, and other networked transaction environments.

The disclosed modules may be deployed as an integrated stack or as interoperable components including identity modules, policy-evaluation modules, namespace-routing modules, liquidity and credit modules, settlement modules, treasury modules, and audit modules.

### ALTERNATIVE EMBODIMENTS

The disclosed modules may be implemented in whole or in part using smart contracts, permissioned ledgers, append-only logs, off-chain compute clusters, hardware security modules, or combinations thereof. Particular embodiments may omit selected modules while still benefiting from the multi-cellular node architecture and shared policy-receipt framework.

Unless explicitly required by the claims, references to particular chains, token standards, AI models, proof systems, or market venues are illustrative and not limiting.

### CLAUSE OF SCOPE

The foregoing description is illustrative and not limiting. Variations, substitutions, combinations, and equivalents that fall within the scope of the appended claims are intended to be covered.

What is claimed is:

1. A computer-implemented decentralized economic infrastructure system comprising:
a node-instantiation manager configured to create a plurality of economic nodes for respective participants, organizations, or jurisdictions, each node being associated with at least one namespace identifier and at least one decentralized identity credential;
a policy engine configured to apply a signed and versioned policy bundle to a requested transfer, exchange, credit, treasury, or settlement operation;
a liquidity routing engine configured to select among a plurality of execution paths across one or more distributed ledgers, layered execution environments, liquidity sources, or institutional adapters;
a settlement coordinator configured to cause execution of the requested operation according to the selected execution path and to generate at least one settlement receipt;
a risk-control engine configured to generate a control output based on at least one fraud signal, exposure signal, collateral signal, liquidity signal, replay-prevention signal, or compliance signal; and
a compliance module configured to load at least one pluggable compliance block specifying route-specific, jurisdiction-specific, or institution-specific eligibility constraints, wherein the policy engine is further configured to use the control output and the at least one pluggable compliance block to determine whether the requested operation is permitted, limited, rerouted, held for review, or denied.

2. The system of claim 1, wherein the at least one decentralized identity credential comprises at least one of a decentralized identifier, a verifiable credential, a public-key credential, an NFT-bound identifier, or a non-transferable identity token.

3. The system of claim 1, wherein the node-instantiation manager is further configured to create a parent node and one or more child nodes that inherit permissions or policy parameters from the parent node, and wherein at least one child node is activated through a domain-to-contract mapping associated with a domain name, subdomain, or delegated namespace identifier.

4. The system of claim 1, wherein the signed and versioned policy bundle specifies one or more of transaction caps, reserve ratios, collateral thresholds, slippage limits, whitelist or blacklist rules, jurisdiction-routing constraints, disclosure constraints, tax or reporting conditions, and compliance rules supplied by the at least one pluggable compliance block.

5. The system of claim 1, wherein the risk-control engine is configured to evaluate both on-chain signals and off-chain signals comprising at least one of repayment history, treasury reserve information, transaction regularity, behavioral consistency, institutional guarantee data, or jurisdiction-linked risk attributes.

6. The system of claim 1, wherein the settlement receipt records at least a route identifier, policy version identifier, timestamp, asset amount, destination reference, and finality state.

7. The system of claim 1, wherein the liquidity routing engine is configured to select among an automated market maker pool, an order-book venue, a bilateral liquidity source, a cross-ledger gateway, and an institutional adapter according to one or more of price, slippage, reserve impact, route latency, availability, policy, and compliance conditions.

8. The system of claim 1, wherein the policy engine is further configured to require a privacy-preserving compliance proof before permitting use of at least one institutional adapter or at least one compliance-sensitive execution path, and wherein the privacy-preserving compliance proof satisfies at least part of the at least one pluggable compliance block without exposing all underlying subject data.

9. The system of claim 1, wherein the settlement coordinator is configured to execute at least part of the requested operation in a sharded environment or layered execution environment and to associate a common receipt chain with multiple execution stages.

10. The system of claim 1, wherein the system is configured to perform a bounded rollback by generating a compensating transaction, escrow unwind, reserve release, or corrective settlement action when predefined evidentiary and policy conditions are satisfied.

11. A computer-implemented method for operating a decentralized credit and treasury network, the method comprising:
receiving, from an initiating economic node, a request for a loan, liquidity allocation, treasury movement, or asset-backed credit operation;
authenticating the initiating economic node through an identity anchor;
determining, by a policy engine, a policy bundle applicable to the request;
computing, by a risk-control engine, a control output based on at least one of transaction history, reserve data, collateral data, repayment data, or route-level liquidity data;
determining, from the policy bundle and the control output, an approved borrowing capacity, liquidity allocation, rate parameter, collateral threshold, or review status; and
causing, by a settlement coordinator, disbursement or movement of digital value and generation of a receipt that records the determined terms.

12. The method of claim 11, wherein the credit operation is permitted under a reduced-collateral or undercollateralized policy when the control output satisfies a threshold based on a combination of reserve backing and non-collateral risk signals.

13. The method of claim 11, further comprising dynamically adjusting an interest parameter, utilization cap, collateral ratio, or maturity window in response to a change in the control output.

14. The method of claim 11, further comprising invoking a liquidation rule, guarantee rule, or protective escrow rule when the control output changes beyond a threshold after disbursement.

15. The method of claim 11, wherein causing disbursement or movement of digital value comprises coordinating a decentralized liquidity source with an institutional adapter that performs fiat settlement, custody confirmation, account verification, or payment-message reconciliation, and optionally linking the resulting movement to a physical card, stored-value credential, or other hybrid payment instrument represented by an on-ledger record.

16. A non-transitory computer-readable medium storing instructions that, when executed by one or more processors, cause the one or more processors to:
resolve a human-readable domain or namespace identifier into one or more authoritative endpoint records for policy, exchange, lending, treasury, audit, or settlement services;
verify at least one signed endpoint record before initiating a requested financial operation;
obtain a governance-approved policy bundle associated with the requested financial operation;
route the requested financial operation among a plurality of interoperable economic nodes according to the governance-approved policy bundle; and
generate an auditable decision receipt and settlement receipt reflecting execution of the requested financial operation.

17. The non-transitory computer-readable medium of claim 16, wherein the endpoint records map a domain name or subdomain to at least one smart-contract address, API endpoint, public key, or service descriptor.

18. The non-transitory computer-readable medium of claim 16, wherein the governance-approved policy bundle is activated in response to a DAO governance event and includes an effective time field that determines when the policy bundle governs subsequently requested operations.

19. The non-transitory computer-readable medium of claim 16, wherein the plurality of interoperable economic nodes includes at least two levels selected from personal nodes, merchant nodes, enterprise treasury nodes, community nodes, public-infrastructure nodes, exchange nodes, insurance nodes, lending nodes, and jurisdiction-linked nodes.

20. The system of claim 1, wherein assets handled by at least one economic node comprise one or more of stable-value tokens, governance tokens, utility tokens, tokenized receivables, settlement tokens, collateral tokens, and credential-linked assets.
